(19) United States
(12) Patent Application Publication
(10) Pub. No.: US 2026/0279699 A1
(43) Pub. Date: Sep. 17, 2026

(54) COOLING DEVICE AND HOUSING FOR A SWITCHING ARRANGEMENT, AND SWITCHING ARRANGEMENT

(71) Applicant: Siemens Aktiengesellschaft, 80333 München (DE)

(72) Inventors: CORNELIUS KÖHLER, Frohburg (DE); FREDERIK MITTELMAIER, Herzogenaurach (DE); STANISLAV PANICERSKI, Nürnberg (DE); ALEXANDER STUMPF, Schwabach (DE)

(73) Assignee: Siemens Aktiengesellschaft, 80333 München (DE)

(21) Appl. No.: 19/167,018

(22) PCT Filed: Feb. 19, 2024
(86) PCT No.: PCT/EP2024/054153

§ 371 Date: Sep. 19, 2025

(30) Foreign Application Priority Data
Mar. 20, 2023 (EP) 23162881.9

(51) Int. Cl. H01H 9/52; H01H 9/02

(52) U.S. Cl. CPC H01H 9/52; H01H 9/02

(57) ABSTRACT

A cooling apparatus for a switching arrangement, in particular for an electronic module of a switch of the switching arrangement, includes a variable cooling module which includes a number of cooling units for mounting in a housing of the switching arrangement. The cooling module Includes a carrier unit designed to receive and hold a variable number of the cooling units, with the cooling units being designed differently and/or homogeneously in terms of cooling capacity, shape, type and/or size.

### DESCRIPTION

The invention relates to a cooling apparatus for a switching arrangement, a housing for a switching arrangement, and such a switching arrangement.

Switches, in particular circuit breakers, high-current switches, outdoor switches, air-insulated switches, are to be designed in such a manner that they have a high rated current carrying capacity. So that the connection contacts of the switch do not heat up excessively during continuous operation when there is a nominal current load, the heat that is generated must be dissipated. For this purpose, a switching arrangement usually comprises a cooling facility for cooling the switch and its power electronics. Various switches, such as, for example, high-voltage switches, medium-voltage switches or low-voltage switches, are known, which are to be cooled in a correspondingly different manner.

WO 01/86681 A1 discloses a control facility having a commercially available switching device and an electronic power module in a compact structure, wherein a copper plate serving as the connection of a contactor is fixedly connected to a heat sink on the outside, and a fan is provided for heat dissipation. U.S. Pat. No. 3,879,100 discloses a circuit breaker having an external connection terminal, which has connection contacts that are designed as heat dissipators.

It is the object of the invention to provide a cooling apparatus for a switching arrangement that meets the different cooling requirements in a simple manner. Furthermore, a housing is to be provided for the switching arrangement, which is of compact design and allows different cooling apparatuses to be accommodated in a simple manner. Furthermore, a switching arrangement having such an improved cooling apparatus and such an improved housing is to be provided.

The first object is achieved In accordance with the invention by a cooling apparatus for a switching arrangement, in particular for an electronic module of a switch of a switching arrangement, wherein the cooling apparatus is formed from at least one variable cooling module having a number of cooling units and can be mounted or is mounted in a housing, wherein the cooling module comprises a carrier unit that is configured so as to receive and hold a variable number of cooling units, wherein the cooling units are configured differently and/or homogeneously in terms of cooling capacity, shape, type and/or size.

For example, all cooling units can be designed identically in terms of cooling capacity, shape, type and/or size. Alternatively or additionally, all cooling units can be designed differently from one another in terms of cooling capacity, shape, type and/or size and thus differently or variably.

Due to such a modularly constructed cooling apparatus that can be mounted in a housing, a plurality of different and/or homogeneous cooling regions can be formed in the housing by the variable number of differently and/or homogeneously configured cooling units. Depending on the configuration of the respective cooling unit itself, different and/or homogeneous cooling zones can additionally be formed in the respective cooling region.

The advantages that are achieved with the invention are, in particular, that a uniform housing is rendered possible for a cooling apparatus having different cooling capacities. This can reduce the number of components and save tool costs, production costs and logistics costs. Due to the uniformity of the housing, the number of units can also be increased without additional effort. By designing the housing as a module housing (also referred to as modularity of the housing) with variable cooling units, any desired cooling combinations and various cooling capacities are rendered possible, for example by any desired material combinations of the variable cooling units. In particular, high cooling capacities can be achieved with a simultaneous compact structure of the cooling apparatus.

The cooling apparatus is in particular formed in a modular manner from the cooling module having the plurality of cooling units. In this case, the cooling apparatus can be preassembled into a mounting module. For example, the carrier unit and the cooling units and optionally a mounting plate can be assembled to form the mounting module. This mounting module can then be mounted in the housing in a simple manner.

Advantageous embodiments of the invention are the subject matter of the subordinate claims.

In one possible embodiment, the carrier unit is designed as a carrier plate to which the cooling units can be fastened or are fastened. The carrier plate can form one of the housing parts.

The carrier plate can be designed as a combined mounting plate and cooling plate. For example, at least one or more of the cooling units can be plugged or mounted on the carrier plate and held thereon in a positive-locking and/or non-positive locking manner and/or connected thereto in a materially bonded manner, for example by adhesive bonding. One of the cooling units itself can also be designed as a carrier, on which further cooling units can be mounted. In particular, the cooling units can be inserted, latched or pressed into one or more receiving arrangements that are formed in the carrier plate and/or the carrier, such as for example receiving grooves.

The carrier plate, the carrier and/or the cooling units can each be formed, for example, from a thermally conductive material, for example from aluminum, copper, a metal alloy, in particular a copper alloy, or another material. The carrier plate, the carrier and/or the cooling units can be designed, for example, as an extruded profile, a cast profile or another molded component.

The carrier plate, the carrier and the cooling units can be designed as separate components. Alternatively, these can also be formed as a single piece as a molded component.

A further embodiment provides that a plurality of adjacent cooling units form at least one cooling region (also referred to as the region to be cooled) having a predefinable cooling capacity. The cooling capacity is understood in particular to mean the thermal energy which is dissipated per unit of time. In addition, several cooling units can be grouped into a cooling group that forms the cooling region. Within a cooling group, all cooling units can be designed homogeneously or identically. Alternatively, these can be designed differently, at least in terms of their performance and/or their material. As a result, different cooling regions can be set. In addition, different cooling zones can be provided within a cooling region.

The housing parts for different cooling apparatuses are advantageously designed as identical parts. This can reduce production costs and logistics costs.

One possible embodiment provides that the cooling units are designed for passive cooling and/or active cooling.

For example, the cooling units can be designed as a plurality of cooling ribs that are arranged parallel to one another and are configured differently and/or homogeneously in terms of cooling capacity, shape, type and/or size. Alternatively, the cooling units can be designed as a plurality of actively cooled plates that are configured differently and/or homogeneously in terms of cooling capacity, cooling medium, shape, type and/or size. Cooling plates can also be designed for passive cooling or convection cooling.

In addition, a plurality of cooling modules is arrangeable or can be arranged one above the other in a stack-like manner. In particular, the plurality of cooling modules are stacked on top of one another when they are in an assembled state. A simple increase in performance is rendered possible by such a modular design, in particular a stacked design, of the cooling apparatus.

With regard to the housing having the cooling apparatus for the switching arrangement, which is designed as a variable cooling module, the object is achieved in accordance with the invention by the design of the housing as a module housing that is formed from a plurality of housing parts that can be connected to one another in a detachable manner and, in the assembled state, jointly enclose a housing interior in which the variable cooling module can be positioned, oriented and/or fixed. In particular, the housing parts are outer housing parts, which are designed, for example, as housing walls. Alternatively or additionally, these outer housing parts can also be formed by modules of the cooling apparatus and/or the switching arrangement itself.

For example, a foundation plate or a base plate can form one of the outer housing parts. The other housing parts can be arranged such that they can be positioned, oriented and/or fixed on the foundation plate or base plate along edges of the base plate.

In addition, the cooling module can be arranged such that it can be positioned, oriented and/or fixed on an inner side of the base plate and can be surrounded by the other housing parts.

In order to position and/or orient the other housing parts to be attached to the base plate and/or the cooling module to be attached, the base plate can comprise a number of positioning elements. For example, a number of positioning elements that are designed as positioning pins can be arranged along the edges of the base plate and/or on an inner side of the base plate, which project perpendicularly from the base plate In the direction of the housing parts to be mounted and/or the cooling module to be mounted.

A switching arrangement in accordance with the invention comprises at least one electronic module, which is to be cooled, of a switch and at least the previously described housing, in the housing interior of which the electronic module is arranged and can be or is thermally coupled to the cooling apparatus. Such a switching arrangement having a uniform housing for different cooling apparatuses having different cooling capacities has a compact structure and can be produced in particular in a simple and cost-effective manner and can be converted in a variable manner.

The switching arrangement can further comprise at least one connection block having electrical connection lines for the switch, which can be or are connected to the switch in an electrically conductive manner, wherein the connection block forms one of the housing parts, in particular an outer housing part. The connection block can be, for example, a single connection or a double connection, wherein a single electrical connection line or two electrical connection lines can be connected for each connection.

The switching arrangement can further comprise at least one cooling supply facility that forms one of the housing parts, in particular a further outer housing part. A fan or an air conditioning system, for example, can be connected upstream of the cooling supply facility.

The above-described characteristics, features and advantages of this invention and also the manner in which these are achieved become clearer and more easily understandable in conjunction with the following description of exemplary embodiments that are further explained in conjunction with the drawings. In the drawings:

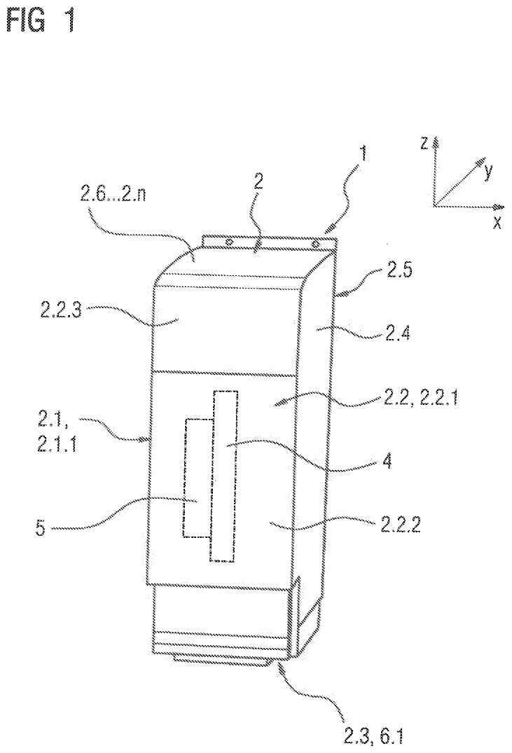

FIG. 1 shows a schematic perspective Illustration of a first embodiment of a switching arrangement and its housing from the rear,

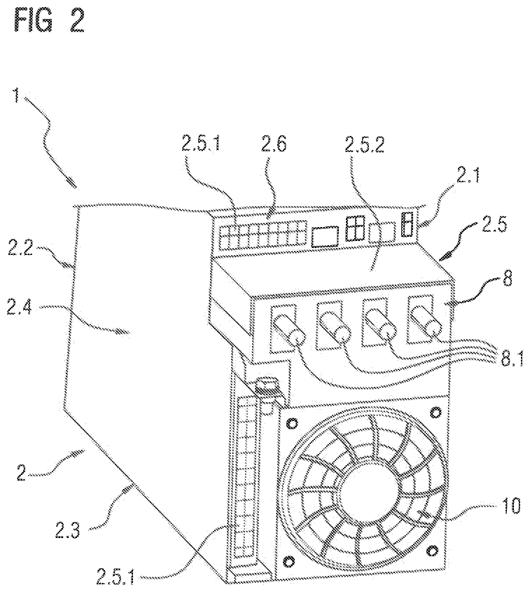

FIG. 2 shows a schematic perspective illustration of the switching arrangement and its housing from the front,

FIG. 3 shows a schematic perspective illustration of a base plate of the housing of the switching arrangement,

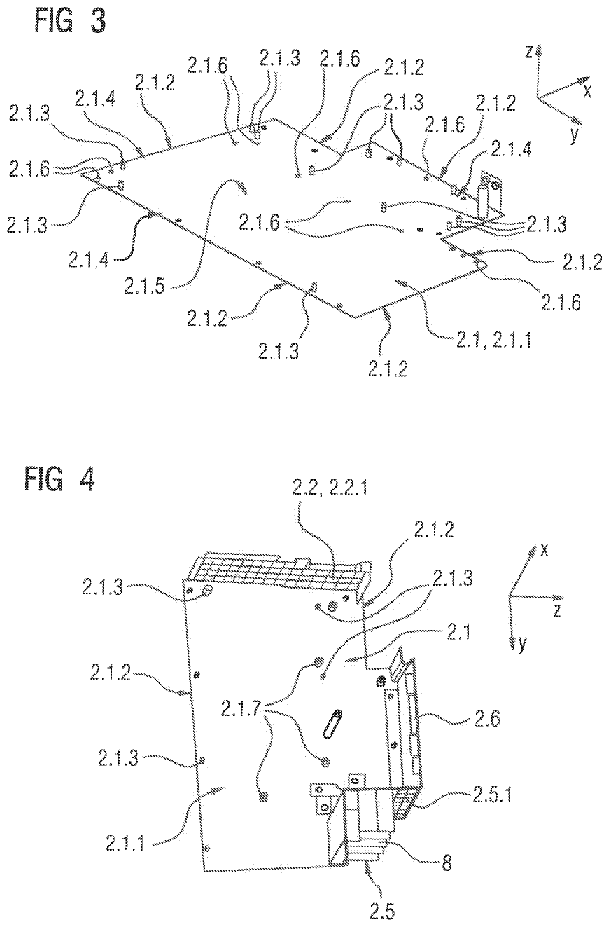

FIG. 4 shows a schematic perspective illustration of the base plate in accordance with FIG. 3 with housing parts arranged along edges,

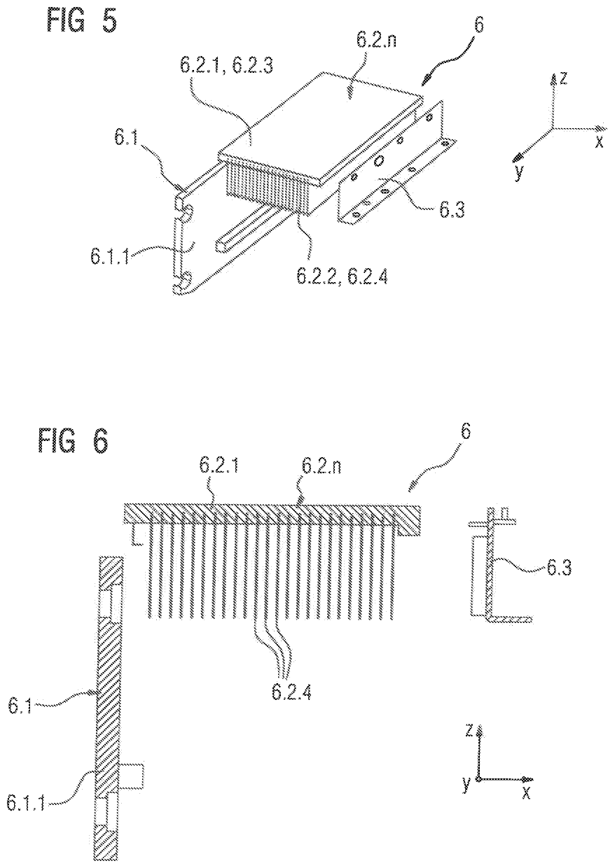

FIG. 5 shows a schematic perspective exploded Illustration of a cooling apparatus,

FIG. 6 shows a schematic side view of a further exploded illustration of the cooling apparatus,

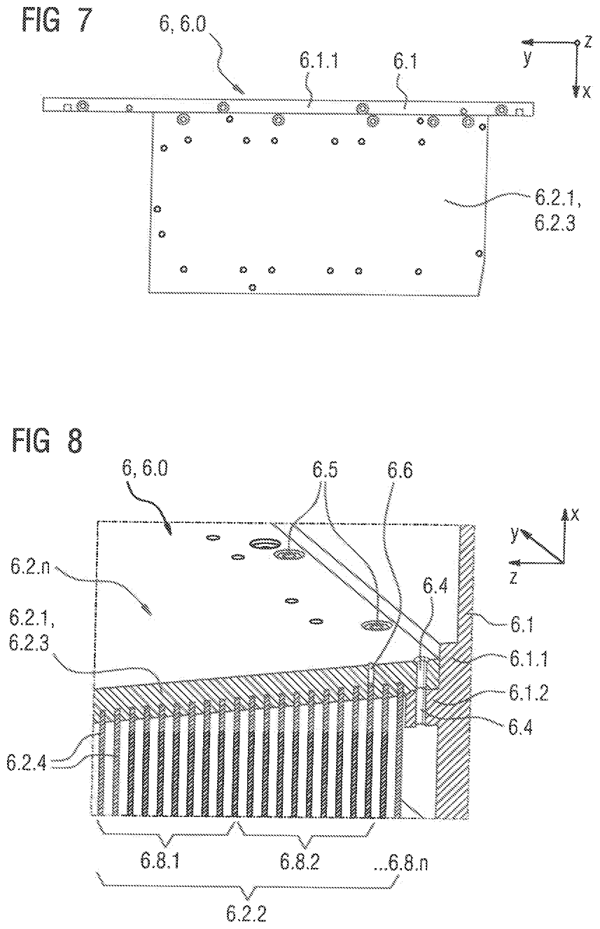

FIG. 7 shows a schematic plan view of the cooling apparatus in the assembled state,

FIG. 8 shows a schematic perspective sectional illustration of the cooling apparatus in the region of a positioning opening,

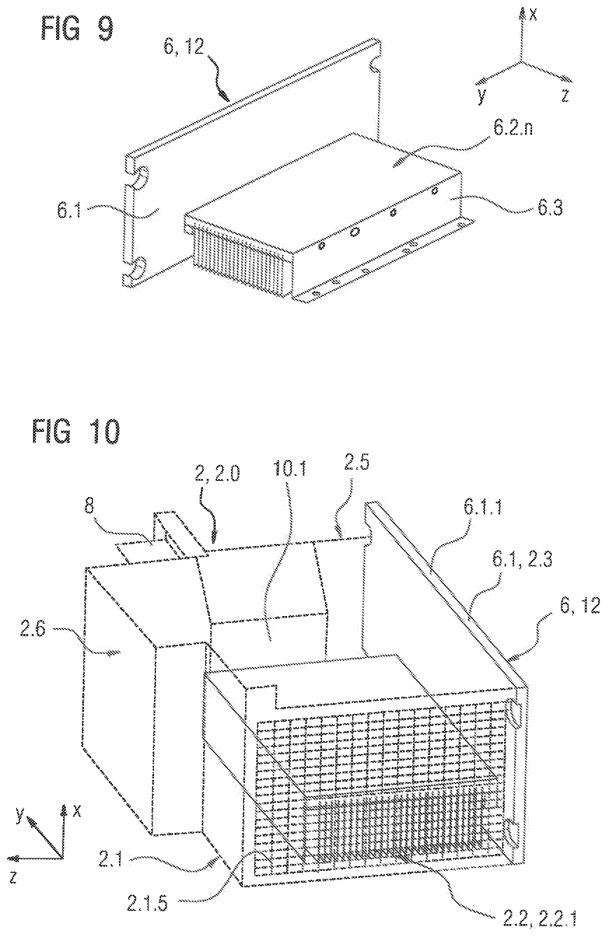

FIG. 9 shows a schematic perspective illustration of the cooling apparatus in the assembled state,

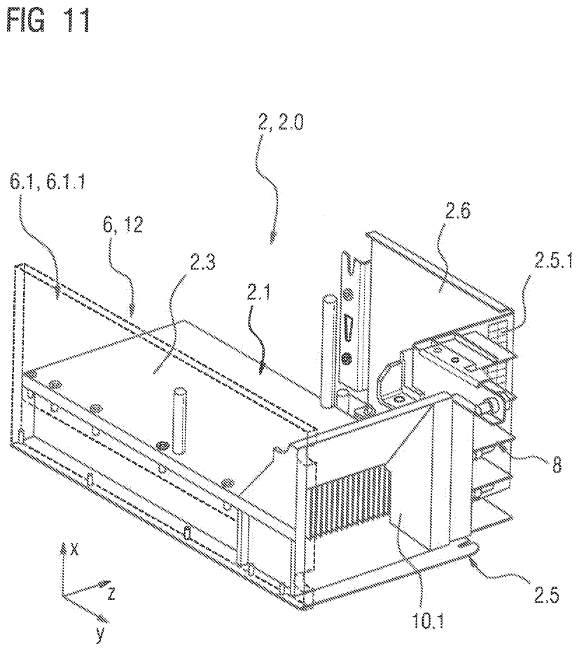

FIG. 10 shows a schematic, partially transparent perspective illustration of a housing that is designed as a module housing with a mounted cooling apparatus for the switching arrangement, and

FIG. 11 shows a schematic, further partially transparent perspective illustration of the housing that is designed as a module housing with a mounted cooling apparatus for the switching arrangement.

Corresponding parts are provided with the same reference characters in the figures.

FIG. 1 illustrates a schematic perspective Illustration of a first embodiment of a switching arrangement 1 from a first side, in particular from a rear side or from the rear.

The switching arrangement 1 is designed as an integrated arrangement. The switching arrangement 1 comprises a housing 2 in which all components of the switching arrangement 1 are arranged in the housing 2 in a combined manner.

The switching arrangement 1 can comprise, as at least one component, a switch 4, in particular a circuit breaker in the form of an outdoor switch, an air-insulated switch, a flow switch, a blower piston switch, a gas-blast switch or another type of an encapsulated switch, and associated electronics 5, in particular power electronics.

The housing 2 is designed as a module housing having a plurality of housing parts 2.1 to 2.n, which can be connected to one another in a detachable manner. In the assembled state, the housing parts 2.1 to 2.n enclose a housing interior.

A first housing part 2.1 forms, at least in regions, an outer side of the switching arrangement 1, in particular a longitudinal side. The first housing part 2.1 is designed as a foundation plate or a base plate 2.1.1, in particular a mounting plate. The first housing part 2.1 is flat and planar, for example.

A second housing part 2.2 forms a further outer side of the switching arrangement 1, in particular a rear side of the switching arrangement 1. The second housing part 2.2 can be formed, for example, by a ventilation grille 2.2.1. In addition, the second housing part 2.2 can be covered at least in regions by a fixed cover unit 2.2.2 and/or a removable or movable flap 2.2.3.

A third housing part 2.3 forms a further outer side of the switching arrangement 1, in particular an underside of the switching arrangement 1. The third housing part 2.3 is formed, for example, by a carrier unit 6.1, in particular a carrier plate 6.1.1, of a cooling apparatus 6 (illustrated in FIGS. 5 to 13). The first housing part 2.3 is flat and planar, for example.

A fourth housing part 2.4 forms a further outer side of the switching arrangement 1, in particular a further longitudinal side of the switching arrangement 1. The fourth housing part 2.4 can be designed as a plate, in particular a mounting plate. The fourth housing part 2.4 is flat and planar, for example.

A fifth housing part 2.5 forms a further outer side of the switching arrangement 1, In particular a front side of the switching arrangement 1. The fifth housing part 2.5 can be formed, for example, in regions by different components. For example, the fifth housing part 2.5 can be formed by a connection block 8 for electrical connection lines 8.1 of the switching arrangement 1 (illustrated in FIGS. 2, 4 and 10 to 13) and/or by a cooling facility 10 (illustrated in FIG. 2 and partially in FIG. 11) and/or by one or more further ventilation grilles 2.5.1 (illustrated in FIGS. 2, 4, 11 and 13).

A sixth housing part 2.6 forms a further outer side of the switching arrangement 1, in particular an upper side of the switching arrangement 1. The sixth housing part 2.6 can be designed as a plate, in particular a mounting plate. The sixth housing part 2.6 is flat and planar, for example.

Further housing parts 2.n can be provided. The illustrated housing parts 2.1 to 2.6 can be designed as a single piece or as multiple pieces.

FIG. 2 shows a schematic perspective illustration of the switching arrangement 1 in accordance with FIG. 1 from a second side opposite the first side, in particular from the front or a front side.

The switching arrangement 1 comprises the connection block 8 having, for example, four electrical connection lines 8.1, which can be or are connected to the switch 4 in an electrically conductive manner.

Furthermore, the switching arrangement 1 comprises the at least one cooling facility 10 for active cooling of the at least one switch 4. The cooling facility 10 is designed, for example, as a fan.

Both the connection block 8 and the cooling facility 10 are arranged and fastened on the housing 2, in particular on the housing parts 2.1 and 2.4 that are designed as longitudinal sides, such that the connection block and cooling facility are accessible from the outside. This enables easy exchangeability of the cooling facility 10 from the switching arrangement 1 and/or easy assembly/disassembly of the connection lines 8.1 on the connection block 8.

For easy access to the connection block 8 and for its protection, the housing 2 can comprise a further protective flap 2.5.2 (also referred to as a protective cap or protective cover). The protective flap 2.5.2 serves as weather protection, protection against solling, protection against the ingress of water, foreign objects and protection of people against potential danger when touching the connection lines 8.1 and/or their connection contacts.

The protective flap 2.5.2 is movably mounted on the housing 2, for example by means of a rotary joint. FIG. 2 illustrates the protective flap 2.5.2 in a position covering and protecting the connection block 8.

The cooling facility 10 can be designed so as to be active. The cooling facility 10 can be designed, for example, as a fan or an air conditioning system (not shown in more detail).

Both the connection block 8 and the cooling facility 10 can be arranged partially in the housing interior of the housing 2.

The further ventilation grilles 2.5.1 are arranged on the edge of the connection block 8 and/or on the cooling facility 10 and cover housing openings of the housing 2 between the connection block 8 and adjacent housing parts 2.6, 2.4, 2.1 and housing openings between the cooling facility 10 and adjacent housing parts 2.1.

FIG. 3 illustrates in a schematic perspective illustration the base plate 2.1.1 of the housing 2 of the switching arrangement 1.

The base plate 2.1.1 forms the first housing part 2.1 and is designed as a mounting plate for easy assembly of the adjacent housing parts 2.2 to 2.6 (illustrated in FIG. 1).

The other housing parts 2.2 to 2.6 can be arranged such that they can be positioned, oriented and/or fixed on the base plate 2.1.1 along edges 2.1.2 of the base plate 2.1.

The base plate 2.1.1 can comprise, for example, a number of positioning elements 2.1.3.

For example, a number of positioning elements 2.1.3 that are designed as positioning pins or bolts can be arranged in an edge region 2.1.4 along the edges 2.1.2 and optionally on an inner side 2.1.5 of the base plate 2.1.1. In this case, the positioning elements 2.1.3 project perpendicularly from the base plate 2.1.1, in particular from the inner side 2.1.5 of the base plate 2.1.1, in the direction of the housing parts 2.2 to 2.6 to be mounted and/or the cooling facility 10 to be mounted. In other words: The positioning elements 2.1.3 protrude perpendicularly into the housing interior.

The positioning elements 2.1.3 and the base plate 2.1.1 can be designed separately and can be fixedly connected to one another. Alternatively, these can be designed as an injection molded part or molded component and thus as a single piece.

In addition, the base plate 2.1.1 can comprise a plurality of fastening openings 2.1.6, into which fastening means, for example a screw, a rivet bolt, a latching lug, a clip or the like, can be inserted, pressed in or introduced for fastening the housing parts 2.1 to 2.6 to one another and/or for fastening modules, such as, for example, the connection block 8 and/or the cooling apparatus 6 (illustrated in FIGS. 5 to 13) and/or the cooling facility 10 to the base plate 2.1.1, for example for screwing to a nut or for riveting. The fastening openings 2.1.6 can be designed so as to be round, circular or slot-shaped or in another suitable shape.

The cooling facility 10 (also referred to as external cooling) is designed as an active cooling and forms an outer side of the housing 2, for example in order to use cold ambient air for cooling when designed as a fan.

The cooling apparatus 6 (also referred to as internal cooling) is designed to be variable and can be designed, for example, as passive cooling, active cooling or a combination of passive and active cooling. The cooling apparatus 6 is arranged in the housing interior of the switching arrangement 1 and can partially form an outer housing wall, in particular the third outer housing part 2.3 (illustrated, for example, in FIG. 10).

FIG. 4 illustrates a schematic perspective illustration of the base plate 2.1.1 in accordance with FIG. 3 with housing parts 2.2, 2.3 and 2.5 arranged in the edge region 2.1.4, which extend completely or in regions along the edges 2.1.2.

The housing parts 2.2, 2.3 and 2.5 mounted on the base plate 2.1.1 are, for example, plugged onto the corresponding positioning elements 2.1.3 that are Illustrated in FIG. 3 during assembly and are thereby oriented and then fastened to the base plate 2.1.1 via screws (not shown) and the fastening openings 2.1.6 (shown in FIG. 3). The fastening openings 2.1.6 can, for example, have an internal thread for screwing in the screws. Alternatively, a corresponding separate nut element can be provided.

The ventilation grille 2.2.1 is mounted on the base plate 2.1.1 as a second housing part 2.2. A mounting plate is mounted on the base plate 2.1.1 as the sixth housing part 2.6. The connection block 8 is mounted on the base plate 2.1.1 as the fifth housing part 2.5.

Further free positioning elements 2.1.3 are provided on the inner side 2.1.5 of the base plate 2.1.1 at a distance from the circumferential edge region 2.1.4 and/or fastening means 2.1.7, for example nut elements or hexagonal elements having an internal thread, which are used in particular for mounting the cooling apparatus 6 (internal cooling) in the housing interior on the base plate 2.1.1, as is shown in detail in FIGS. 10 to 13).

FIG. 5 illustrates a schematic perspective exploded illustration of a cooling apparatus 6, which is designed as a variable cooling module 6.0.

The cooling apparatus 6 comprises a carrier unit 6.1, which is designed, for example, as the carrier plate 6.1.1, in particular as a mounting plate or a combined cooling and mounting plate. In the installed state of one of the housing parts 2.n, in particular the third housing part 2.3 in the example shown, the carrier plate 6.1.1 forms an underside of the housing 2 of the switching arrangement 1, as illustrated in FIG. 1 or 10.

The cooling apparatus 6 is designed as a variable cooling module 6.0. For this purpose, the carrier unit 6.1 is configured, for example, to receive and hold a variable number of cooling units 6.2.n. The cooling units 6.2.n are in turn of variable design. The cooling units 6.2.n can be designed differently and/or homogeneously, for example in terms of cooling capacity, shape, type and/or size.

In the example shown in FIG. 5, the cooling apparatus 6 comprises a large-area cooling plate as a carrier 6.2.3 as a first cooling unit 6.2.1 and a plurality of cooling ribs 6.2.4 (also referred to as cooling walls or cooling plates) as a second cooling unit 6.2.2, which protrude perpendicularly from the first cooling unit 6.2.1. The large-area cooling plate can be manufactured as a passive cooling plate, in particular from a thermally conductive material. In addition, the large-area cooling plate can be designed as an active cooling plate, through which, for example, a cooling medium, such as cooling air, flows for heat dissipation.

For example, all cooling units 6.2 can be designed identically in terms of cooling capacity, shape, type and/or size. Alternatively or additionally, all cooling units 6.2 can be designed differently from one another in terms of cooling capacity, shape, type and/or size and thus differently or variably.

The cooling units 6.2 can be fastened on one side to the carrier plate 6.1.1 and on the other side additionally to a mounting plate 6.3. The carrier plate 6.1.1 forms an outer side of the housing 2. The mounting plate 6.3 is designed as an inner wall in the housing interior.

For example, at least one cooling unit 6.2 can be plugged onto the carrier plate 6.1.1 and held thereon in a positive locking and/or non-positive locking manner.

The first cooling unit 6.2.1, which is designed as a large-area plate, can also be designed as a carrier 6.2.3 of the other cooling units 6.2.n. For example, the carrier 6.2.3 can have receiving arrangements, such as for example receiving grooves, into which the other cooling units 6.2.n can be inserted, latched, pressed in, glued in, welded in and introduced by means of other suitable means.

The components of the cooling apparatus 6, in particular the carrier plate 6.1.1, the cooling units 6.2.n and the mounting unit 6.3 can each be formed from a thermally conductive material, for example from aluminum, copper, a metal alloy, in particular a copper alloy, or another material. The carrier plate 6.1.1, the carrier 6.2.3, the cooling ribs 6.2.4 and/or the mounting plate 6.3 can be designed, for example, as an extruded profile, a cast profile or another molded component.

In order to increase the performance of the cooling apparatus 6, a plurality of cooling modules 6.0 are arrangeable or can be arranged one above the other in a stack-like manner in the housing 2 (Illustrated in FIGS. 1 and 2). In particular, the plurality of cooling modules 6.0 are stacked on top of one another when they are in an assembled state.

FIG. 6 shows schematically a further exploded illustration of the cooling apparatus 6 in a side view.

The carrier plate 6.1.1 and the cooling units 6.2.n can be designed as separate components. Alternatively, these can also be formed as a single piece as a molded component.

The first cooling unit 6.2.1, which is designed as a carrier 6.2.3, and the second cooling unit 6.2.2, which is designed as cooling ribs 6.2.4, can likewise be designed as separate components or as a single piece, as a molded component.

The mounting plate 6.3 is designed separately and can additionally be designed as passive cooling. The mounting plate 6.3 is designed as a side carrier for the cooling units 6.2.n.

FIG. 7 illustrates a schematic plan view of the cooling apparatus 6 in the assembled state. The first cooling unit 6.2.1 is designed as a flat carrier 6.2.3. The carrier plate 6.1.1 extends laterally along a longitudinal side of the first cooling unit 6.2.1. The mounting plate 6.3 (illustrated in FIGS. 5 and 6) is arranged below the first cooling unit 6.2.1, that is to say the first cooling unit 6.2.1 rests on an end face of the mounting plate 6.3.

FIG. 8 illustrates a schematic perspective sectional illustration of the cooling apparatus 6 in the region of a positioning opening 6.4 for orienting and positioning the cooling units 6.2.n with respect to the carrier unit 6.1, in particular with respect to the carrier plate 6.1.1.

The carrier plate 6.1.1 has an inner shoulder 6.1.2 for supporting the first cooling unit 6.2.1, which is designed as a carrier 6.2.3. Both the carrier 6.2.3 and the inner shoulder 6.1.2 are provided with mutually corresponding positioning openings 6.4, in which, for example, positioning means (not shown) designed as pins or bolts can be arranged for orienting and positioning the cooling units 6.2.n with respect to the carrier unit 6.1 and the housing 2.

The first cooling unit 6.2.1 is fastened to the carrier unit 6.1 by means of connecting elements 6.5, for example screws, bolts or rivets.

The second cooling unit 6.2.2, which is designed as cooling ribs 6.2.4, can be designed as a single piece with the first cooling unit 6.2.1, the carrier 6.2.3 of the cooling ribs 6.2.4, as a cast part or molded component. Alternatively, grooves 6.6 can be provided into which cooling ribs 6.2.4 can be Inserted and are held. In particular, the cooling ribs 6.2.4 are held in the grooves 6.6 in a positive locking and/or non-positive locking manner. For example, the cooling ribs 6.2.4 can be pressed into the grooves 6.6.

A further embodiment provides that a plurality of adjacent cooling units 6.2.2 form a plurality of different cooling regions 6.8.n (also referred to as the region to be cooled) having a predefinable cooling capacity. The cooling capacity is understood in particular to mean the thermal energy which is dissipated by the heat sink per unit of time. Preferably, different cooling capacities can be provided in the cooling regions 6.8.n.

For example, a plurality of cooling ribs 6.2.4 can form a cooling region 6.8.n. Within the respective cooling region 6.8.n, all cooling units 6.2.n can be designed homogeneously or identically. As a result, the respective cooling region 6.8.n has a homogeneous cooling capacity.

Alternatively or additionally, the plurality of cooling ribs 6.2.4 of a cooling region 6.8.1 or 6.8.2 can be designed differently, at least in terms of their performance and/or their material. As a result, different cooling capacities can be provided within the respective individual cooling region 6.8.1 or 6.8.2.

In other words: A plurality of different or homogeneous cooling regions 6.8.n can be formed in the housing 2 by means of the cooling apparatus 6 with different and/or homogeneous cooling units 6.2.n.

The cooling regions 6.8.1 or 6.8.2 are preferably each provided homogeneously, but with different cooling capacities, so that different cooling zones can additionally be provided.

In the example according to FIG. 8, the cooling ribs 6.2.4 of the first cooling region 6.8.1, which are arranged parallel to one another, differ in terms of cooling capacity, shape, type and/or size from the cooling ribs 6.2.4 of the adjacent second cooling region 6.8.2, which are arranged identically parallel to one another. Within the respective cooling region 6.8.1. and 6.8.2, identical and thus homogeneous cooling ribs 6.2.4 are provided in each case. As a result, a different cooling zone is provided by means of the first cooling region 6.8.1, for example with a higher cooling capacity for a higher heat dissipation than by means of the second cooling region 6.8.2 with a lower cooling capacity for a lower heat dissipation.

In the example shown, the cooling ribs 6.2.4 are designed as passive cooling plates or cooling webs or cooling walls. Alternatively, the cooling units 6.2.n, in particular the carrier 6.2.3 and the cooling ribs 6.2.4, can be designed as actively cooled plates.

Such variability of the cooling units 6.2.n enables a variable cooling module 6.0 for the switching arrangement 1.

FIG. 9 Illustrates a schematic perspective illustration of the cooling apparatus 6 described above with reference to FIGS. 7 and 8 in the assembled state. The cooling apparatus 6 can be preassembled into a mounting module 12. In this case, the carrier unit 6.1, the cooling units 6.2.n and the mounting plate 6.3 are assembled to form the mounting module 12. This mounting module 12 can then be mounted in the housing 2 of the switching arrangement 1 in a simple manner, as is shown below with reference to FIGS. 10 to 13.

FIG. 10 illustrates a schematic, partially transparent perspective illustration of a housing 2 that is designed as a module housing 2.0, in the housing interior of which the cooling apparatus 6, which is preassembled as a mounting module 12, is mounted.

The mounting module 12 is mounted, for example, in its entirety on the base plate 2.1. In particular, the mounting module 12, in particular its mounting plate 6.3 and its carrier plate 6.1.1, is plugged onto the positioning elements 2.1.3 (illustrated in FIGS. 3 and 4) on the inner side 2.1.5 of the base plate 2.1 and mounted, for example connected to one another by means of connecting elements 6.5, such as screws. The carrier plate 6.1.1 forms the third housing part 2.3 and an underside of the switching arrangement 1.

In an analogous manner, the connection module 8 and a cooling medium supply facility 10.1 (illustrated in FIG. 11) for the cooling facility 10 (illustrated in FIG. 2) are plugged onto positioning elements 2.1.3 in the edge region 2.1.4 of the base plate 2.1 (illustrated in FIG. 3) and connected to one another in a mounted manner, for example by means of screws. The cooling medium supply facility 10.1 and the connection module 8 form the fifth housing part 2.5 and the front side of the switching arrangement 1. A mounting plate forms the sixth housing part 2.6 (upper side) and is plugged and mounted in an analogous manner on positioning elements 2.1.3 in the edge region 2.1.4 of the base plate 2.1. The ventilation grille 2.2.1 forms the second housing part 2.2 (rear side) and is plugged and mounted in an analogous manner on positioning elements 2.1.3 in the edge region 2.1.4 of the base plate 2.1.

FIG. 11 illustrates a schematic, further partially transparent perspective illustration of the housing 2, which is designed as a module housing 2.0, with a cooling apparatus 6 that is mounted as a mounting module 12, a mounted cooling medium supply facility 10.1 for the cooling facility 10 (illustrated in FIG. 2), a mounted connection block 8, and a mounted mounting plate that forms the sixth housing part 2.6 (for example an upper side).

The cooling facility 10, the connection block 8 and the further ventilation grille 2.5.1 form the fifth housing part 2.6 (for example a front side).

The carrier unit 6.1 with the carrier plate 6.1.1 of the mounting module 12 forms the third housing part 2.3 (for example an underside) The carrier plate 6.1.1, the cooling facility 10, the connection block 8, and the ventilation grille 2.5.1, as well as the mounting plate that forms the sixth housing part 2.6, are all mounted perpendicularly on the base plate 2.1.1 that forms the first housing part 2.1 (for example a longitudinal side).

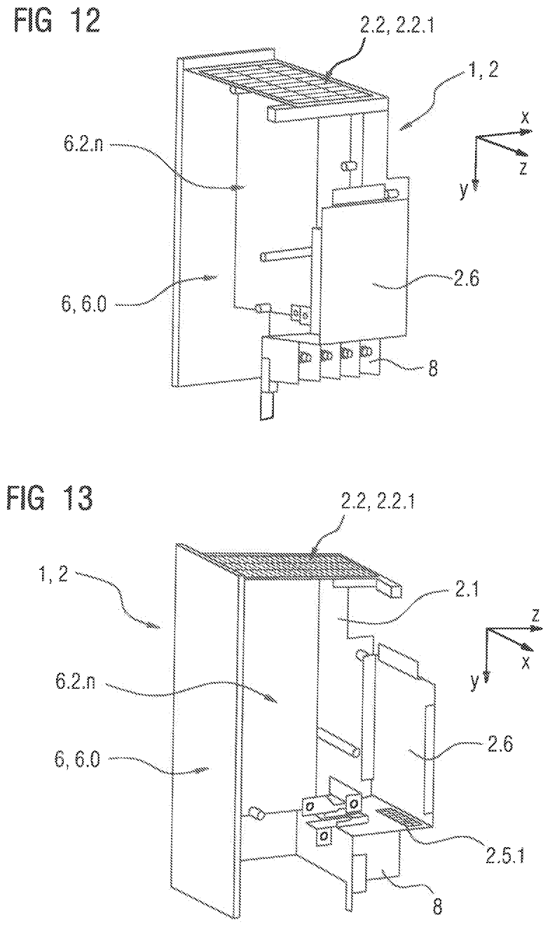

FIGS. 12 and 13 illustrate two further perspective illustrations of the partially open housing 2 of the switching arrangement 1 without internal components, such as switches 4 and electronics 5 (illustrated abstractly in FIG. 1).

The cooling apparatus 6, designed as a variable cooling module 6.0, as described above, is mounted as an entire mounting module 12 on the base plate 2.1.1 of the housing 2.

The housing parts for different cooling apparatuses are advantageously designed as identical parts. This can reduce production costs and logistics costs.

Although the invention has been further illustrated and described in detail by the preferred exemplary embodiments, the invention is not limited in this regard by the disclosed examples and other variations can be derived therefrom by the person skilled in the art without departing from the scope of the invention.

1.-15. (canceled)

16. A cooling apparatus for a switching arrangement, comprising a variable cooling module comprising a number of cooling units for mounting in a housing of the switching arrangement, said cooling module comprising a carrier unit designed to receive and hold a variable number of the cooling units, said cooling units being designed differently and/or homogeneously in terms of cooling capacity, shape, type and/or size.

17. The cooling apparatus of claim 16, constructed for an electronic module of a switch of the switching arrangement.

18. The cooling apparatus of claim 16, wherein the carrier unit is designed as a carrier plate for fastening at least one of the cooling units.

19. The cooling apparatus of claim 16, wherein a plurality of adjacent ones of the cooling units form a cooling region having a predefinable cooling capacity.

20. The cooling apparatus of claim 16, wherein the cooling units are designed for passive cooling and/or for active cooling.

21. The cooling apparatus of claim 16, wherein the cooling units are designed as a plurality of cooling ribs that are arranged parallel to one another and are designed differently and/or homogeneously in terms of cooling capacity, shape, type and/or size.

22. The cooling apparatus of claim 16, wherein at least one of the cooling units is formed by a cooling plate that is designed as a carrier.

23. The cooling apparatus of claim 16, further comprising a plurality of said variable cooling module arranged one above the other in a stack-like manner.

24. A housing for accommodating the cooling apparatus of claim 16, the housing comprising a plurality of housing parts detachably connectable to one another to form a module housing and jointly enclosing in an assembled state a housing interior for positioning, orienting and/or fixing therein the variable cooling module of the cooling apparatus.

25. The housing of claim 24, wherein one of the housing parts is designed as a base plate, on which the other ones of the housing parts are arranged such as to enable positioning, orienting and/or fixing of the other ones of the housing parts along edges of the base plate.

26. The housing of claim 25, wherein the other ones of the housing parts surround the cooling module as the cooling module is arranged for positioning, orienting and/or fixing on an inner side of the base plate.

27. The housing of claim 26, wherein the base plate comprises a number of positioning elements for orienting the other ones of the housing parts and/or the cooling module.

28. The housing of claim 24, wherein the housing parts for different cooling apparatuses are designed as identical parts.

29. A switching arrangement, comprising:
a housing comprising a plurality of housing parts detachably connectable to one another to form a module housing and jointly enclosing in an assembled state a housing interior for positioning, orienting and/or fixing therein a cooling apparatus designed as a variable cooling module; and
a switch comprising an electronic module to be cooled, said electronic module being arranged in the housing interior and thermally coupled to the cooling apparatus.

30. The switching arrangement of claim 29, further comprising a connection block comprising electrical connection lines for connection to the switch in an electrically conductive manner, said connection block comprising a region to form one of the housing parts.

31. The switching arrangement of claim 29, further comprising a cooling medium supply facility, which comprises a region to form one of the housing parts.
